(19) United States
(12) Patent Application Publication
(10) Pub. No.: US 2019/0323798 A1
(43) Pub. Date: Oct. 24, 2019

(54) Storage System with Location Controlled Access and Associated Methods

(71) Applicants: Christopher Link, Olathe, KS (US); Alan Pineiro, Hollywood, FL (US)

(72) Inventors: Christopher Link, Olathe, KS (US); Alan Pineiro, Hollywood, FL (US)

(21) Appl. No.: 16/392,306

(22) Filed: Apr. 23, 2019

Related U.S. Application Data
(60) Provisional application No. 62/661,477, filed on Apr. 23, 2018.

(51) Int. Cl. F41C 33/06; E05B 73/00; G06F 21/32; E05B 47/00

(52) U.S. Cl. CPC F41C 33/06; E05B 73/00; E05B 2047/0096; E05B 47/00; G06F 21/32

(57) ABSTRACT

A storage case includes an electronic lock that is configurable into a locked state. A processor of the storage device configures the lock into the locked state when location information, captured by a location device in the storage case, indicates that the storage case is within a predetermined area surrounding an entity. The storage case may be opened by an authorized user, even if within the predetermined area, via interaction of the storage case with an override device.

### CROSS-REFERENCE TO RELATED APPLICATION

This application claims priority to U.S. Provisional Application Ser. No. 62/661,477 filed Apr. 23, 2018, the entire content of which is incorporated herein by reference.

### BACKGROUND

Transportation of sensitive objects, such as hazardous materials, chemicals, biological materials, and firearms, is monitored carefully. Transportation of such sensitive objects via airlines requires check-in and inspection at Transportation Security Agency (TSA) checkpoints. While TSA checkpoints provide one point of security for travelers entering the airport, such checkpoints do not prevent travelers from accessing the sensitive objects once they reach their destination. For instance, the tragic shooting at the Fort Lauderdale Airport on Jan. 6, 2017, included a traveler accessing a weapon from a checked baggage obtained at the baggage claim of his final destination (Fort Lauderdale), after the checked baggage had passed security checkpoint at the origin city.

### BRIEF DESCRIPTION OF THE FIGURES

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

FIG. 1 depicts a system for geographic-location controlled access to a storage case, in embodiments.

FIG. 2 depicts the locking system of the storage case of FIG. 1 in further detail.

FIG. 3 depicts a method for operating a storage system with location controlled access, in embodiments.

FIG. 4 depicts a method for generating an alert in response to a sensed condition of the storage case of FIGS. 1-2, in embodiments.

### DETAILED DESCRIPTION OF THE EMBODIMENTS

Embodiments of the systems and methods described herein solve the above identified problems—security related to sensitive objects at location (e.g., hotel, house, resort, corporate or educational campus, event center, airport, destination city, etc.)—by preventing access to the sensitive object until a traveler (or user) is outside a predetermined geographical area. The present embodiments relate to methods and systems for monitoring and, optionally, controlling, storage cases using sensor devices that are configured to GPS/GNSS, cellular or other communication methods such as LPWA technologies such as LoRa and Sigfox, etc, and platform based geofencing and remote monitoring. This will help control a special lock and associated software application platform which sends and receives signals over a signaling channel of a wireless communications network. The Sensor device is configured to enable/disable the storage case lock mechanism in accordance with instructions received by the Platform. Movements and/or attempt to open the storage case will be monitored by the platform which receives information concerning the storage case location and condition.

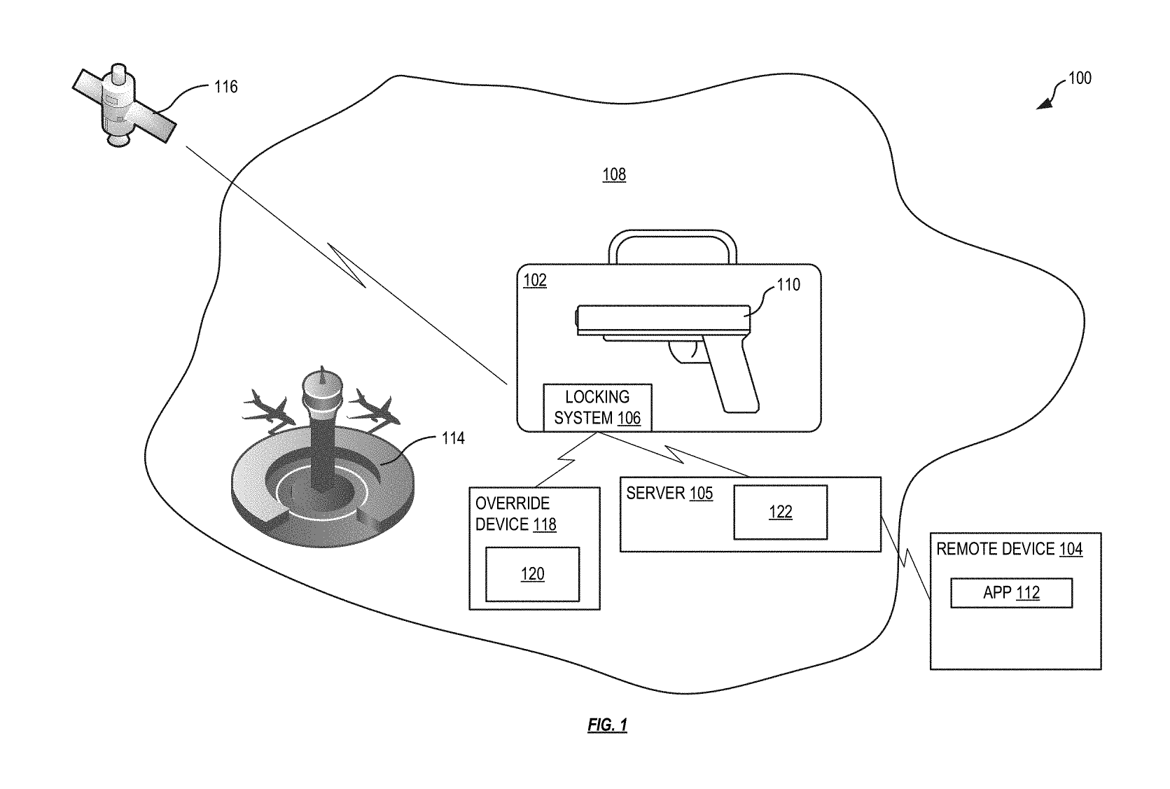

FIG. 1 depicts a system 100 for geographic-location controlled access to a storage case 102, in embodiments. System 100 includes the storage case 102, and at least one remote device 104. The storage case 102 is illustrated storing/accommodating a firearm 110. However, it should be appreciated that the storage case 102 may store additional or alternative objects, such as but not limited to, ammunition, pharmaceuticals, crop shipments, high value luggage, pharmaceuticals, drug samples, blood samples, etc.

The storage case 102 includes a locking system 106 that is configured to control access within the storage case 102 based upon the geographic location of the storage case 102 as compared to a predetermined area 108, and associated settings (e.g., settings 215 discussed below). The predetermined area 108 may be configured based on interaction with the remote device 104. The remote device 104 may communicate with a server 105 which is in communication with the storage case 102, or may communicate directly with the locking device 106 via a short-range communication channel (e.g., Bluetooth). The server 105 may operate as a cloud server, or other platform for managing functionality within the system 100. Although the server 105 is located within the predetermined area 108 in FIG. 1, it may be located outside of the predetermined area 108. For example, the remote device 104 may be a smart phone, a tablet, a laptop, or other computing device that includes a case lock application 110 used to set the predetermined area 108 and interface with the storage case 102. The remote device 104 is registered to the storage case 102, and such registration details (such as identification information of the remote device 104, the identification of the user thereof, and the identification information of the storage case 102 and locking system 106) are stored in one or both of the server 105, or the remote device 104. In one example, the remote device 104 is owned or used by the traveler using the storage case 102. In embodiments, the predetermined area 108 is configured based on an authorized user (such as a TSA agent) setting the predetermined area 108 around a location of interest (such as an airport).

The predetermined area 108 may be a geo-location fence that defines an area in which the storage case 102 enters and remains in a locked state. For example, the predetermined area 108 in FIG. 1 is illustrated as surrounding an entity 114. The predetermined area 108 may be a radius around a given location (such as the entity 114), or may be a geo-location fence defined by longitude and latitude coordinates, streets, or other landmarks that set the boundary of the predetermined area 108. The entity 114 may be one or more of an airport, train station, ship, bus station, school, church, movie theatre, hotel, house, event center, corporate campus, resort, etc. In embodiments, the predetermined area 108 is not contiguous, but instead surrounds multiple entities individually (e.g., a predetermined area 108 around each airport within the country, or a predetermined area 108 around each hotel). Accordingly, a user of the storage case 102 desiring to travel from a first city to a second city may be required to utilize storage case 102 to transport firearm 110. The non-contiguous predetermined area (e.g., surrounding multiple airports) allows added security both at the departing airport, and at the arriving airport after the user picks up the storage case 102 from the baggage claim because the user cannot open his/her bag upon arrival.

The locking system 106 is in wireless communication with a satellite device 116 to determine location of the storage case 102. In one example, the satellite device 116 is a Global Navigation Satellite System (GNSS) device configured to operate according to one or more positioning protocols including, but not limited to, GPS, GLONASS, Galileo, Beidou and other regional systems. It should be appreciated that the locking system 106 may determine/obtain location information via location identification means other than GNSS, such as cellular triangulation and/or last known cellular tower coordinates as available through a cellular module within the locking system 106. When the locking system 106 determines that the storage case 102 is in a given geo-location fence (such as the predetermined area 108), the storage case 102 may be locked such that the object(s) within the storage case 102 is/are inaccessible.

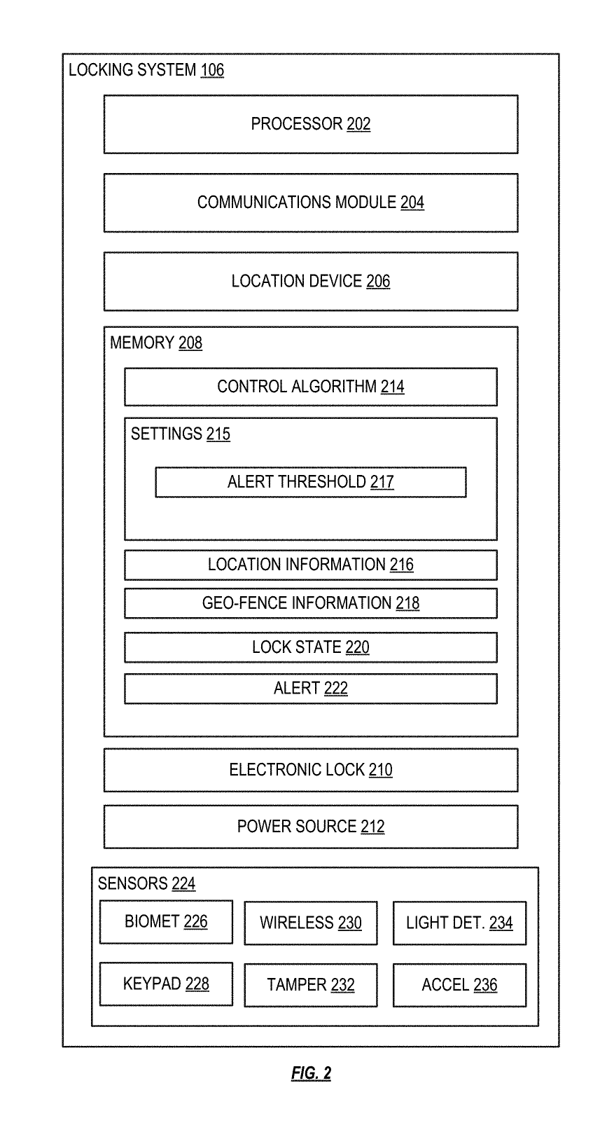

FIG. 2 depicts the locking system 106 of the storage case 102 of FIG. 1 in further detail. The locking system 106 includes a processor 202, a communications module 204, a location device 206, a memory 208, an electronic lock 210, and a power source 212. Components of the locking system 106 may be interconnected within the locking system 106 via a databus, a power bus, or other wired or wireless connections.

The processor 202 may include one or more microprocessors or other computing devices capable of executing computer readable instructions.

The communications module 204 may include a transceiver, such as a cellular communications module configured to communicate and receive data according to a wireless protocol. The wireless protocol may be any known wireless protocol including, but not limited to, cellular 2G GSM/GPRS, CDMA/1xRTT, 3G UMTS/HSPA+ or HSDPA, 4G LTE CAT 1 and above, 5G, IoT LTE CAT M1, CAT NB1 (Narrow-Band IoT), Bluetooth, Wi-Fi, LoRA, Sigfox, Z-Wave, ZigBee, or the like.

The location device 206 is any device capable of determining the location of the storage case 102. For example, the location device 206 may be configured to receive GNSS signals from the satellite device 116 determine the location of the storage case 102 based thereon. As such, the location device 206 may be in wireless communication with the satellite device 116 of FIG. 1. In some embodiments, the location device 206 is the same as the communications module 204, such as when the location of the storage case 102 is determined based on cellular triangulation. The communication module 204 and the location device 206 may be integrated such as in an integrated GPS cellular chipset.

The memory 208 may include transitory and/or non-transitory memory, volatile (e.g., RAM, DRAM, SRAM) memory, and non-volatile (e.g., Hard disk, Solid State Drive, Optical disk, floppy disk, EEPROM, SSD, NAND memory). The memory 208 may store a control algorithm 214 including computer readable instructions that when executed by the processor 202 operate to control operation of components of the storage case 102, such as the communications module 204, the location device 206, and the electronic lock 210. For example, the control algorithm 214 may periodically analyze signals received at the location device 206 from the satellite device 116 to determine location of the storage case 102. As another example, the control algorithm 214 may receive geo-fence information 216 from the remote device 104 (or the server 105) defining the predetermined area 108. As another example, the control algorithm 214 may compare the location information 216 to the geo-fence information 218 to determine if the storage case 102 is located within the predetermined area 108 and configure a lock state 220 controlling whether the electronic lock 210 is locked or unlocked.

Various aspects of the control algorithm 214 may be performed at a remote server platform without departing from the scope hereof. For example, one or both of the location information 216 and the geo-fence information 218 may be transmitted, via the communications module 204, from the storage case 102 to a remote server (such as server 105), as well as from the remote server to the case 106. The geo-fence information 218 may define the predetermined area 108 in which the storage case 102 is not accessible unless unlocked via the override device 118. In embodiments, the geo-fence information 218 is defined within the server 105 via an entity access portal 122. The entity access portal 122 allows an entity, such as entity 114, to register the desired predetermined area 108 around said entity at which access to storage case 102 (or other storage cases similarly equipped) is limited or prevented. For example, the TSA may access entity access portal 122 and indicate that access to storage case 102 is prevented within a X mile radius around all airports in the United States. Similarly, a hotel chain may access entity access portal 122 and indicate that access to storage case 102 is prevented within a Y mile radius around all hotels owned by that hotel chain.

The electronic lock 210 may include a locking mechanism (such as a solenoid, magnetic lock, or other locking device) capable of electronic activation according to the lock state 220.

The power source 212 may include a battery, and/or a hardwired power source. In one example, the power source 212 is a rechargeable battery integrated into the storage case 102, and that is recharged via connection of the power source 212 to a wall power source, the wall power source being coupled to the power source 212 via a port (not shown) located in the storage case 102.

Referring to FIG. 1, the storage case 102 may be inaccessible when the storage case 102 is located within the predetermined area 108. However, in embodiments, an override device 118 may be capable of transmitting an override signal 222 (FIG. 2) to the locking system 106 thereby configuring the lock state 220 to allow access to the storage case 102 even when the storage case 102 is within the predetermined area 108. The override signal 222 may be verified by the control algorithm 214 (such as via authentication of the override device 118) to prevent unauthorized access to the storage case 102 when within the predetermined area 108. The override device 118 may allow authorized access (such as by airlines and TSA agents at an airport, or other persons whenever the case 106 is locked) access to the storage case 102, and an ability to re-lock after inspection at the airport or other location. As such, the override device 118 may include an authentication module 120 (such as a biometrics scanner (e.g., fingerprint, retinal, etc.), password input, pin code, etc.) used to verify an authorized user (e.g., the TSA agent, hotel manager, etc.) to allow opening of the case 102.

The control algorithm 214 may additionally include information for generating alerts 222. Alerts 222 may be configurable based on one or more alert thresholds 217 stored within settings 215. The alert thresholds 217 within settings 215 may be configured in the memory 208 via communication with the case 106 from remote device 104, server 105, and override device 118. In one example, the alert thresholds 217 indicate to generate the alert 222 when the storage case 106 enters or exits the geofence 108. In another example, the alert thresholds 217 indicate to generate alert 222 based upon locking/unlocking of the storage case 106. In another example, the alert thresholds 217 indicate to generate alert 222 when the battery level of power source 212 is below a given threshold. In another example, the alert thresholds 217 indicate to generate alert 222 based on data captured from one or more additional sensors 224 of the storage case 102 while the storage case 102 is in a monitoring state.

The additional sensors 224 may include biometrics sensor 226 (e.g., fingerprint scanner, retinal scanner, facial recognition camera, etc.), number/alphabet/alphanumeric keypad 228, NFC/short-range/long range wireless transceiver 230, tamper detector 232, light detector 234, accelerometer 236. In embodiments, various ones of the sensors 224 may be a single piece of hardware. For example, the biometrics sensor 226 may be a camera that performs facial recognition (or fingerprint/retinal scanning) and also light detection as the light detector 234. As another example, the accelerometer 236 may be capable of tamper detection 232 when the case 106 is hit or accessed causing the accelerometer 236 to indicate the case 106 is being broken into.

Settings 215 allow the owner of storage case 106 to control and receive information of the storage case 106 even when the case 106 remains inside the predetermined area 108. In other words, the storage case 102 may be placed within a “monitoring state” that analyzes data captured at the storage case (e.g., one or more of the location information 216, the power source 212, or the sensors 224). Each authorized user of the storage case 106 may have a keycode that is stored within the settings 215. The keycode may be a biometric scan used with the biometrics sensor 226, an alphanumeric code for entry in the keypad 228, or a NFC/short-range/long range wireless code for receipt by transceiver 230. If the keycode is entered, the alert thresholds 217 may indicate for control algorithm 214 to generate alert 222 indicating what user has accessed the case. Similarly, if the case 106 is accessed when unauthorized, such as determined via tamper detector 232, unexpected acceleration detected via accelerometer 236, or opening when the light detector 234 indicates that the case is open (because it is light within the case when it should be dark), the alert thresholds 217 may indicate for the control algorithm 214 to generate alert 222. As another example, when in the monitored state, the power source 212 may be coupled to a wired power source (e.g., plugging of the power source 212 to into a wall power source). An alert threshold 217 may cause the control algorithm 214 may then monitor when the power source 212 is unplugged, indicating removal of the storage case 102 from the location near the wall power source. In response to this indicated removal, the control algorithm 214 may generate alert 222.

The alert 222 may be generated at the case 106, or at the server 105. If generated at the server 105, the server 105 may implement the control algorithm 214 and settings 215, and data from the location information 216, geofence information 218 and sensors 224 may be transmitted from the case 106 to the server 105. The alert 222 may be transmitted to the remote device 104. This provides the advantage that a case owner is always aware of when the objects within the case 106 are being accessed, even if the owner is not near the case 106.

A use case for the storage case 106 will now be described. An owner may register themselves and their child. This registration may include interacting with one or more of the sensors 224 to provide a keycode for storage in settings 215. One example is registering the biometrics of the owner and child using biometrics scanner 226. Another example is entering an alphanumeric code into the keypad 228. Another example is pairing an NFC/wireless device (such as the remote device 104, or the override device 118) with the transceiver 230 (the paired wireless device may provide two- or single-stage authentication using the paired device). In order for the owner or child to access the object stored within the case 106 after registration, the owner or child must enter their keycode. Upon entry of the keycode, a variety of procedures may occur. In one example, the electronic lock 210 may unlock. In another example, an alert 222 may be sent to the remote device 104 and the electronic lock 210 may unlock. In another example, an alert 222 may be sent to the remote device 104 requesting approval to activate electronic lock 210. In such example, the electronic lock 210 may not unlock until the remote device 104 transmits an approval signal back to the case 106 (directly or via server 105).

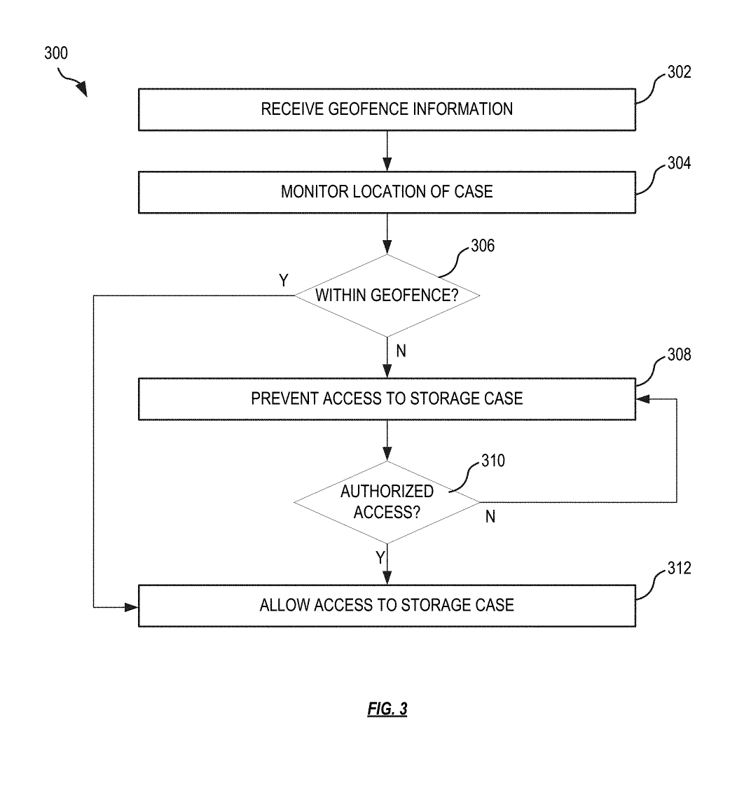

FIG. 3 depicts a method 300 for operating a storage system with location controlled access, in an embodiment. Method 300 may be implemented using system 100 discussed above with respect to FIGS. 1-2. For example, the method 300 may be implemented within the control algorithm 214 of the locking system 106 of storage case 102.

In block 302, the method 300 receives geofence information. In one example of block 302, the storage case 102 receives geofence information 218 from a remote server 105 defining at least one predetermined area 108. For example, the entity 114 may access the server 105 via the entity access portal 122 and indicate the parameters of the predetermined area 108. These parameters are then transmitted to the storage case 102 as geofence information 218 indicating the geofence at which, when the storage case 102 is located therein, the storage case 102 is to be inaccessible unless unlocked via the override device 118.

In another example of block 302, a user of the storage case 102, such as the owner thereof, interacts with the remote device 104 to determine the parameters of the predetermined area 108. For example, the user may indicate to set a geofence around a current location of the storage case 102 when the storage case 102 is located at the user's house to monitor movement of the storage case 102 away from the user's house. These parameters set via interaction with the remote device 104 are then transmitted to the storage case 102 (either directly, or via the server 105) and stored within the memory as geofence information 218.

In block 304, the method 300 monitors the location of the storage case. In one example of block 304, the location device 206 of the locking system 106 of storage case 102 captures location information 216. The control algorithm 214 then analyzes this location information 216 to determine the current location of the storage case 102.

In block 306, the method 300 determines if the storage case is within the geofence. In one example of block 306, the control algorithm 214 compares the current location of the storage case 102 against the geofence information 218 to determine if the storage case 102 is within the geofenced defined by the predetermined area 108. If so, then method 300 proceeds to block 308, else method 300 proceeds to block 312.

In block 308, the method 300 prevents access to the storage case. In one embodiment of block 308, the control algorithm 214 configures lock state 220 to locked and the electronic lock 210 is controlled to lock the storage case 102 thereby preventing access to the storage case 102. In embodiments of method 300, the storage case 102 remains in the locked lock state 220, and repeats block 306 until it is determined that the storage case 102 is no longer within the geofenced defined by predetermined area 108.

In embodiments of method 300, block 310 is implemented to determine if authorized access is attempted while access to the storage case is being prevented. In one example of block 310, control algorithm 214 determines if an access request is received via the communications module 204 from the override device 118. If the access request is received then the method 300 proceeds with block 312, else method 300 resumes operation pursuant to block 308. In certain embodiments of block 310, the access request is received by the communications module 204 in response to verification of an authorized user of the override device 118 using the authentication module 120.

In block 312, the method 300 allows access to the storage case. In one embodiment of block 312, the control algorithm 214 configures lock state 220 to unlocked and the electronic lock 210 is controlled to unlock the storage case 102 thereby allowing access to the storage case 102.

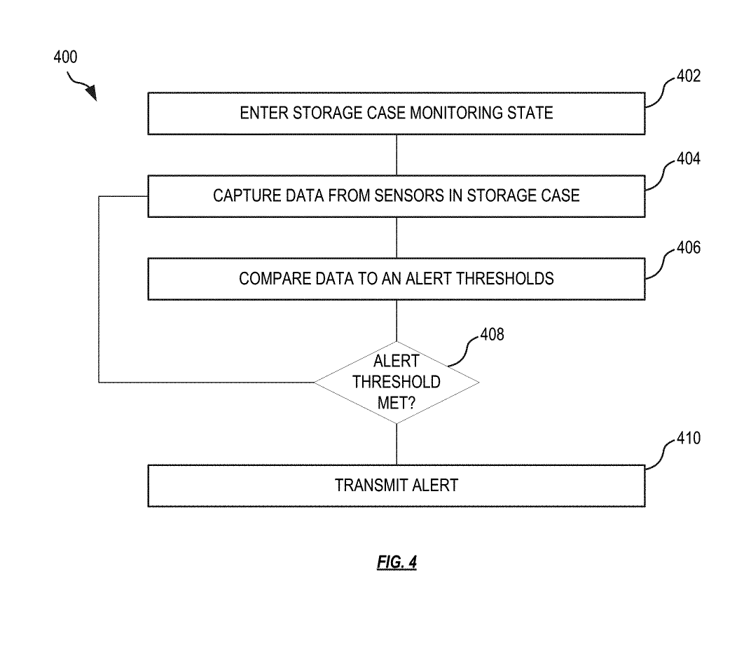

FIG. 4 depicts a method 400 for generating an alert in response to a sensed condition of the storage case 102 of FIGS. 1-2, in embodiments. Method 400 may be implemented using system 100 discussed above with respect to FIGS. 1-2. For example, the method 400 may be implemented within the control algorithm 214 of the locking system 106 of storage case 102. Method 400 may be performed simultaneously as, before, after, or without performance of method 300 discussed above.

In block 402, the method 400 transitions the storage case into a monitoring state. In one embodiment of block 402, the control algorithm 214 transitions the locking system 106 into a lock state 220 indicating to lock and monitor the storage case 102.

In block 404, the method 400 captures data from sensors in the storage case. In one example of block 404, the control algorithm 214 captures data from one or more of the location device 206, the communications module 204, the power source 212, the biometric sensor 226, the number/alphabet/alphanumeric keypad 228, the NFC/short-range/long range wireless transceiver 230, the tamper detector 232, the light detector 234, and the accelerometer 236.

In block 406, the method 400 compares the captured data from block 404 against one or more alert thresholds. In one example of block 406, the control algorithm 214 compares the captured data in block 404 against one or more alert thresholds 217. The alert thresholds 217 may be received in method 400 from a remote device 104, or server 105, prior to execution of block 406.

In block 408, the method 400 determines if an alert threshold is met based on the comparison in block 406. If so, method 400 proceeds with block 410, else method 400 loops back to block 404. There are a variety of examples that indicate alert thresholds 217 being met. In one example of block 408, the control algorithm 214 determines that an alert threshold 217 is met when it is determined in block 406 that the location information 216 indicates that the storage case 102 is outside of the geo-fence defined by the geo-fence information 218. In another example of block 408, the control algorithm 214 determines that an alert threshold 217 is met when it is determined in block 406 that the storage case is locked or unlocked via entry of a code into the keypad 228, scanning of a biometric data via the biometric sensor 226, or receipt of a wireless signal at NFC/short-range/long range wireless transceiver 230. In another example of block 408, the control algorithm 214 determines that an alert threshold 217 is met when the battery level of power source 212 is below a given threshold. In another example of block 408, the control algorithm 214 determines that an alert threshold 217 is met when sensed light by the light detector 234 is above a predetermined threshold indicating ambient light when it should be dark because the storage case 102 is closed. In another example of block 408, the control algorithm 214 determines that an alert threshold 217 is met when accelerometer data from the accelerometer 236 indicates movement of the storage case 102. In another example of block 408, the control algorithm 214 determines that an alert threshold 217 is met when the power source 212 is unplugged from wall power.

At block 410, method 400 transmits an alert to a remote device. In one example of block 410, the control algorithm 214 generates alert 222 corresponding to the alert threshold 217 met. The alert 222 may be transmitted to one or more of the remote device 104, the server 105, and the override device 118. In examples, the alert 222 may be transmitted to a monitoring service, via the server 105, such as the police, or a safety monitoring service that has access to the server 105 via the entity access portal 122. In embodiments where method 400 is performed via control algorithm 214 residing on the server 105, the alert 222 is transmitted from the server 105 to one or more of the override device 118, the remote device 104, and a third-party monitoring service.

The above described systems and methods provide many advantageous use cases. For example, a parent/legal guardian of a stored firearm (e.g., firearm 110) or other sensitive item may receive immediate response, via one of alerts 222, in response to an unauthorized access, or access attempt, by other persons (such as a child) to the storage case. The alert 222 triggered by the captured data from sensor suite 224 may be sent to the parent/legal guardian's remote device (e.g., remote device 104) such that the parent/legal guardian has immediate knowledge of the attempted access. Optionally, after generation of the alert, additional information (such as last known location, current location, registered person contact information, etc.) may be transmitted via the communication module 204 to server 105 for information access by a third part such as the police or a professional monitoring service.

As another example, the storage case 102 may be located within schools and accessible only by authorized users (such as teachers, school resource officers, school principals, and other trained staff) via their use of the override device 118. Furthermore, multiple storage cases 102 may be located throughout a given building (e.g., school). The items within the storage case may be locked defensive weapons in the case of an emergency such as an active shooter situation. Storage cases containing locked weapons can be located within multiple zones at a facility with the added safety that unauthorized users cannot access the contents therein, and if they did, for some reason, a variety of other authorized users would be aware of said access via generation of an alert 222. A central security may then transmit activation signals to one or more of the multiple storage cases 102 (and received by the communications module 204) that either control the electronic lock 210 to unlock, or activate a lock state 220 of each storage case 102 that allows the override device 118 to unlock the storage case. Accordingly, a central security may “activate” only certain storage cases in response to location of a potential threat in the building. and then an authorized user at those certain storage cases may use an override device 118, or input a security code in to the keypad 228, to unlock the storage case 102. Each activated storage case can be remotely enabled to allow secondary entry-code using keypad 228, retinal scan or other biometric access using biometric scanner 226, or access using reader 230 or override device 118 by trained, authorized staff once their zone is enabled by the facility's central security and/or local law enforcement with access to the platform for that facility (e.g., via entity portal 122).

As another example, travelers with legal weapon registrations, concealed permits, hunters, etc. at times need to store weapons or other sensitive items such as ammunition with them during airport, resort, hotel, or Corporate workday/visit situations where the facility, such as a resort, selects to use this solution to control access to the weapons within a geofence of their facility. Use of the storage case 102 allows the owner to retain possession of the storage case. In this example, access to the case via the registration methods described earlier, is allowed outside of the resort/facility pre-defined geofence (e.g., predefined area 108 defined by the resort/facility via entity portal 122), therefore allowing access for hunting trips, normal concealed weapon use outside of the facility as allowed by local laws, etc. Loaned or leased systems are likely in this example, owned and controlled by facility central security, and provided upon registration by the users.

As yet another example, the tracking and access control and/or monitoring/logging of access events is described for the delivery of controlled substances such as legal marijuana shipments from growers to dispensaries is provided. Individual items recorded for shipment may be RFID tagged (and such data stored in server 105, or memory 208), for logging and inventory tracking using RFID readers at the end-point locations. The tracking technology within the storage case 102 (such as a data log of the location information 216, or scanned location using NFC/short-range/long range wireless transceiver 230) will log access points at the growing facility or between the facility and dispensary locations. Said logged access points may then be stored in memory 208, or transmitted to the server 105. Controlled access can be implemented as in the above examples by remote cellular or other wireless enablement by the platform, and a secondary access by authorized users via digital access codes, retinal scans, or other biometric methods using biometric scanner 226, or override device 118. Unauthorized access or tampering will be logged and alerts are sent to the owners for appropriate response.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A storage system having location controlled access, comprising:
a storage case having a locking mechanism including:
an electronic lock,
a location device,
a communications module,
a processor, and
memory storing computer readable instructions that when executed by the processor operate to:
receive, via the communications module, geo-fence information defining a predetermined area surrounding an entity,
compare location information, captured by the location device, to determine whether the storage case is within the predetermined area, and,
when the storage case is within the predetermined area, activate the electronic lock according to a locked state.

2. The storage system of claim 1, the storage case configured to accommodate a firearm.

3. The storage system of claim 1, the memory storing further computer readable instructions that when executed by the processor operate to:
while the storage case is in the locked state, receive an access request via the communications module from an override device, and
in response to the received access request, deactivate the electronic lock according to an unlocked state.

4. The storage system of claim 3, the override device being registered with the entity.

5. The storage system of claim 3, the access request being generated at the override device in response to verification of an authorized user of the override device using an authentication module at the override device.

6. The storage system of claim 1, the entity being an airport.

7. The storage system of claim 6, the predetermined area including multiple, non-contiguous predetermined areas surrounding a plurality of airports.

8. The storage system of claim 1, the memory storing further computer readable instructions that when executed by the processor operate to generate an alert when the predetermined area is breached.

9. The storage system of claim 1, the memory storing further computer readable instructions that when executed by the processor operate to:
capture data from at least one internal sensor within the storage case,
determine if an alert threshold is met by the captured data, and,
generate an alert when the alert threshold is met.

10. The storage system of claim 1, the at least one internal sensor including a light detector, the alert threshold including a light threshold.

11. The storage system of claim 1, the at least one internal sensor including an accelerometer, the alert threshold including acceleration of the case above a predefined threshold.

12. The storage system of claim 1, the at least one internal sensor including a biometric sensor, the alert including identification of a user registered with the biometric sensor.

13. The storage system of claim 1, the at least one internal sensor including a keypad, the alert including identification of a user registered with a code input into the keypad.

14. The storage system of claim 1, the at least one internal sensor including a power source, the alert threshold including a disconnection of the power source from wall power.

15. A method for location controlled access to a storage case, comprising:
monitoring current location of the storage case;
comparing the current location against a predetermined area; and,
locking the storage case when the current location indicates the storage case is within the predetermined area.

16. The method of claim 15, the predetermined area being a geofence around an airport.

17. The method of claim 16, the predetermined area including a plurality of non-contiguous geofences respectively around one of a plurality of airports.

18. The method of claim 15, further comprising, allowing access to the storage case when the storage case is within the predetermined area in response to an access request received from an override device.

19. The method of claim 15, further comprising generating an alert in response to the current location indicating the storage case has entered the predetermined area.
